(19) United States
(12) Patent Application Publication
(10) Pub. No.: US 2019/0208965 A1
(43) Pub. Date: Jul. 11, 2019

(54) SANITARY WARE AND METHOD OF MAKING SAME

(71) Applicants: Volker GERHARD, Hamm (DE); Karsten HARTMANN, Ahlen (DE)

(72) Inventors: Volker GERHARD, Hamm (DE); Karsten HARTMANN, Ahlen (DE)

(21) Appl. No.: 16/239,733

(22) Filed: Jan. 4, 2019

(30) Foreign Application Priority Data
Jan. 5, 2018 (DE) 102018100159.2
Jul. 25, 2018 (DE) 102018118041.1

(51) Int. Cl. A47K 1/04; A47K 3/40; C04B 41/45

(52) U.S. Cl. CPC A47K 1/04; A47K 3/002; C04B 41/45; A47K 3/40

(57) ABSTRACT

A method of making a sanitary basin. The method has the steps of providing a steel basin body, coating a face of the body with a layer of enamel, and burning macroscopic structures into the enamel coating with a laser beam. The structures are interconnected, for example forming a channel network.

### FIELD OF THE INVENTION

The present invention relates to sanitary ware, for instance a bath sink or shower base. More particularly this invention concerns a method of making the sanitary ware.

### BACKGROUND OF THE INVENTION

A sanitary basin has a body made of metal and an enamel coating on the body. The invention further relates to a sanitary basin preform, particularly for forming a sanitary basin according to the invention, and to a manufacturing method.

Such combinations of a body made of steel and an enamel coating thereon are also generally referred to as steel enamel. Sanitary basins made of steel enamel are characterized by high scratch, abrasion, and impact resistance and are hygienic and stain-resistant. In addition, the high-quality appearance of steel enamel is of long duration, with no color or surface changes occurring even under the influence of chemicals and heat.

The person skilled in the art is familiar with the manufacture of enamel and enameled products. Reference is made in this respect to the “Römpp Chemie Lexikon” (“Römpp's Chemistry Lexicon”), vol. 2, 9th edition, 1990, pp. 1147ff and to “Ullmanns Encyklopadie der technischen Chemie” (“Ullmann's Encyclopedia of Industrial Chemistry”), vol. 10, 4th edition, 1975, pp. 436-447.

Quartz, feldspar, soda, calcium carbonate, borax, sodium nitrate, and fluorspar and aggregates are used as raw materials for making enamel, depending on the intended use. The raw materials are mixed and melted at about 1200° C. and solidified, producing a frit in the form of granules or flakes.

The frit is ground and usually mixed with water to form a paste that is applied to the steel surface to be coated, usually a steel sheet. Before firing, the enamel coating is dried, the dried layer also being referred to as an enamel biscuit or simply biscuit.

In the context of the invention, the preform is the intermediate product that is produced in this way before the final firing process. This is true even if, in the case of a multilayer, typically two-layer application of enamel with a base enamel and a top enamel, the base enamel coating is already baked on and the top enamel coating is present thereon as a biscuit layer.

The sanitary basin can be a bathtub or a shower pan, for example. A basin is generally understood as being a body with a raised outer edge surrounding a vessel-shaped depression. The vessel-shaped depression is also usually slightly pitched toward a drain opening. In the context of the invention, bodies that deviate from the standard sense of the word are also referred to as basins. It is thus conceivable, for example, for a sanitary device that is embodied as a shower pan to consist of a substantially planar body that has a defined pitch only when installed, the slope being directed toward an outlet at the edge. The seal is created by special sealing tapes. Therefore, a broad interpretation of the term “basin” is generally required.

With sanitary basins made of steel enamel, the danger always exists of the user slipping on the surface of the sanitary bath due to moisture.

A thin film of water forms between the human skin and the surface whose formation is further promoted by surface-active substances such as those contained in personal care products such as shower gels, bath products, shampoos, or skin-care products.

In order to make a surface slip resistant, it is thus already known to break through the surface film at least in part by producing edges and roughness.

In this context, US 2004/0105966 describes a sanitary basin made of metal with an enameled surface, with the enameled surface being provided in at least one section with an anti-slip coating. The anti-slip coating consists of a granular inorganic material that is firmly bonded to the enameled surface by firing.

Alternatively, DE 4309019 describes a sanitary basin having a non-slip floor surface produced by mechanical roughening. The roughening is done by blasting using corundum or glass beads by etching, brushing, or grinding. The described method is primarily suitable for basins made of acrylic glass, but it is also intended to be used for enameled steel basins. However, the mechanical removal of material from enameled surfaces is very elaborate in terms of production engineering. In addition, mechanical material removal has the disadvantage of damaging the high-quality enameled surface.

Moreover, slip-resistant structures according to U.S. Pat. Nos. 6,167,879 and 6,434,897 EP 0 825 917 B1 can also be produced by generating microcraters by a laser. Such a manner of application for steel enamel basins is also known from DE 20 2016 003 216, according to which small depressions or elevations are introduced into the surface of the already-formed shower pan or bathtub by the laser. Overall, however, this method has room for improvement.

### OBJECTS OF THE INVENTION

It is therefore an object of the present invention to provide an improved sanitary ware and method of making same.

Another object is the provision of such an improved sanitary ware and method of making same that overcomes the above-given disadvantages, in particular that modifies a sanitary basin such that it is easy to manufacture and it has especially effective anti-slip properties on the surface, more particularly on the surface walked on by the user.

### SUMMARY OF THE INVENTION

A method of making a sanitary basin has according to the invention the steps of providing a steel basin body, coating a face of the body with a layer of enamel, and forming macroscopic structures into the enamel coating with a laser beam. In the context of the invention a “macroscopic structure” is a structure in the form of an elevation or depression having a length of at least 4 mm, preferably 10 mm or more, and/or a base area of at least 1 mm².

The invention is based on the insight that the water film can be broken up in a targeted manner by such macroscopic structures. If the macroscopic structures are depressions, it is expedient for the macroscopic structures to be configured in such a way that the base area of the depression is suitable for receiving and/or dissipating at least part of the water quantity. In the case of macroscopic structures in the form of elevations, then the valleys between the elevations should fulfill this task.

In a preferred embodiment of the invention, the structures are interconnected. For example, a channel network can then be created by the macroscopic structures, in which case the individual channels are either branched or arranged successively one after the other. It is also possible for such an arrangement of macroscopic structures to form a self-contained channel system, for example in the form of a rectangle or a circle.

The body is pitched, it being possible for the macroscopic structures to be aligned on this slope. Such an orientation of macroscopic structures serving as channels can transport the water in a targeted manner toward the drain opening. It is unimportant here whether the macroscopic structures are interconnected or not. If the macroscopic structures are not interconnected, an array of a plurality of grooves in a star shape around the drain opening is recommended that are embodied in the form of depressions or even two adjacent arranged depressions. The channels can for example be straight or wave-shaped or zigzag-shaped. When using interconnected macroscopic structures, at least individual structures are aligned on the slope and/or extend toward the drain opening. The macroscopic structures that do not extend toward the slope can then preferably be branched off from at least one structure that extends toward the drain opening.

Often however, transporting of water by the described macroscopic structures is not crucial. Instead, it is considered essential to provide edges at which the water film is locally disrupted. Particularly in the case of linear structures, the effective edge length is decisive for a wavy course. In this context, it should also be observed that the generation of the macroscopic structures by lasers generally does not result in a straight but rather a wavy edge course. A certain wavy structure and an associated irregularity is particularly advantageous for the interruption of a coherent water film. On the other hand, larger disruptions should be avoided.

For the macroscopic structures to achieve a good anti-slip effect, the macroscopic structures preferably have a depth in the range from 10 μm to 150 μm. The depth of the macroscopic structures is especially preferably between 20 μm and 50 μm, particularly between 30 μm and 40 μm.

In the case of a linear configuration of the macroscopic structures, the width can be between 35 μm and 250 μm, for example, with a range between 70 μm and 130 μm being especially preferred.

It should be noted that the specified values refer to a mean line width, since the edges are not straight but extend in a certain wavy or jagged shape. For example, if a linear macroscopic structure having a line width of 85 μm is formed, the variation in the line width can typically lie in a range between −8 μm and +15 μm. Such a variation in the line width is readily acceptable and is even advantageous because the irregular course increases the effective edge length.

It is also advantageous if the macroscopic structures have a mutual spacing in the range from 1 mm to 20 mm, preferably in the range from 2 mm to 7 mm. This mutual spacing is intended to ensure that a sufficient number of macroscopic structures can be arranged in a corresponding surface section of the sanitary basin, so that the amount of water can also be effectively absorbed or transported away.

As a matter of principle, it lies within the scope of the invention that the macroscopic structures can be distributed over the entire surface of the sanitary basin. Preferably, however, macroscopic structures are provided only where an anti-slip effect is required. For example, the edge areas of a sanitary basin may be able do without such structures. The proportion of the surface of the sanitary basin that is provided with macroscopic structures is in the range from 5% to 100%, for example between 40% and 50%. In the case of shower pans in particular, it may also happen to be advantageous if the entire surface is provided with macroscopic structures.

The invention also relates to a sanitary basin preform that is particularly intended to form a sanitary basin according to the invention having a body made of steel and a enamel coating on the body, with the enamel coating carrying at least one unfired frit layer in the form of a biscuit layer. According to the invention, this sanitary basin preform is characterized in that the unfired structure layer is modified with a laser beam. In the context of the invention, the sanitary basin preform is to be understood as a semifinished product from which an enameled sanitary basin can be formed.

The sanitary basin preform according to the invention is based on the insight that the unfired structured layer of enamel frits can already be modified with a laser in such a way that, after a final firing process, no further steps are required in order to form an anti-slip surface. In particular, laser processing of the surface that has undergone final firing can then be dispensed with. In this way, the problem of an already-finished topcoat being potentially damaged by the laser processing such that the water impermeability is compromised is avoided. According to the present invention, only the sanitary basin preform is processed, so that possible damage that may already be present can be compensated for before the firing process. What is more, the modification of a sanitary basin preform is advantageous in terms of process management compared to the modification of a sanitary basin that has undergone final firing.

According to the conventional configuration, the enamel coating is composed of one to three sublayers. In the case of a three-layer construction, there is the enamel layer consisting of a base layer and a cover layer thereon, and the frit layer is on the cover layer. In principle, however, it is also possible to 10o form the coating in only two layers with a cover layer and a structure/frit layer, in which case the cover layer is composed of so-called direct white. This is especially possible if the basin preform is made of nickel-plated steel. Finally, a single-layer construction is possible, in which case the macroscopic structures are then introduced with the laser into the still-unfired layer of direct white. Particularly in the case of a basin preform made of nickel-plated steel and a sufficiently thick biscuit layer of the not-yet-fired direct white, this is readily possible in the context of the invention.

The laser can then be used to make various types of modifications in order to achieve anti-slip structures in the unfired structure or frit.

According to a first variant, the unfired structure layer has notches burnt in by the laser beam. The laser beam thus removes ground enamel frits or the (dried) slip in the structure layer. The laser beam must be of sufficiently high energy in order to do this. This is usually done using a pulsed laser such as a Nd:YAG laser or a CO² laser. The laser energy is concentrated here in a short time pulse so that very high laser power is available for a brief moment.

The depth of the notch is generally limited to the thickness of the structure layer, the structure or frit preferably having a thickness in the range from 100 μm to 200 μm. Since the cover layer and, optionally, also a base layer beneath the structure layer must not be damaged during the modification by a laser beam, a smaller depth of the notch is best, with it being preferred for the structure layer to have at least a residual layer thickness of 50 μm, for example.

According to another embodiment of the invention, a modification by laser can also be provided such that the structure layer is fixed only partially to the cover layer with the laser beam. In contrast to a full-surface structure layer with notches introduced according to this variant, the structure layer is no longer spread over the entire surface of the cover layer and thus forms by itself an anti-slip surface in the form of elevations on the cover layer. In this case as well, both an at least two-layer structure with a cover layer of direct white and a three-layer structure with an additional layer are possible. The structure or frit is fixed to the cover layer such that the enamel frit layer is partially melted with the laser beam and thereby solidified. The non-solidified regions of the structure layer can then be removed, in which case the solidified regions remain on the cover layer in the form of ridges or bumps.

In contrast to the modifications already known from the state of the art, macroscopic structures such as channels, for example, that are formed in an especially preferred manner can already be introduced into or applied to the sanitary basin preform. There is thus a complete modification of the sanitary basin preform that is then formed into a finished sanitary basin through a final firing. Subsequent processing of the fired structure layer is not required.

In addition to a sanitary basin and a sanitary basin preform, a method of making a sanitary basin according to the invention constitutes part of the invention. A sanitary basin preform is first formed such that an enamel coating is applied to a body made of steel with an unfired structure or frit, upon which the unfired structure layer is modified by a laser beam. For this purpose, the enamel coating typically has a one- to three-layer construction. In the case of an at least three-layer construction, a base layer is first applied to the body, and a cover layer is then applied to this base layer. A firing process for fixing the individual layers to the body is usually carried out between the application of the individual layers. The unfired structure layer of enamel frits is then applied to the cover layer and then modified with a laser beam.

If the enamel coating has a two-layer design, the cover layer can be applied directly to the body. An additional base layer is thus not required. In this method, a cover layer of so-called direct white is used. Furthermore, the body must be a body of nickel-plated steel.

A two-layer construction is also possible if a base layer is initially applied and fired before the described structuring is then performed in a sufficiently thick cover layer. The cover layer then coincides with the structuring layer.

After all, a single layer and thus a single firing process is also likewise sufficient if nickel-plated steel and a sufficiently thick layer of direct white are used.

The application of the enamel coating or of the individual layers of the enamel coating can be performed by all application methods that are known from the prior art, with it being readily understood that, as in the frit layer, the enamel can be applied wet in the form of ground enamel frit or as a liquid slip in a spraying process, dried, and subsequently fired. To produce anti-slip structures, the cover layer is then modified with the laser, with two different modification methods having proven to be advantageous that have already been described in connection with the sanitary basin.

According to a first variant, material is removed by the laser beam and, as a result, notches or grooves are produced in the unfired structure layer. For this purpose, preferably lasers are used that generate a pulsed laser beam, such as an Nd:YAG laser or CO² laser. It is possible as a matter of principle to focus the laser beam and then aim it directly onto the unfired structure layer.

According to a second variant of the method, the laser beam partially melts and solidifies material of the unfired structure layer. In contrast to the previous method, there is thus no removal of material or no appreciable removal of material, but rather only a partial fixation of the structure layer as a result of the effect of heat from the laser beam. As a result of the fixation in certain areas, solidified and non-solidified regions thus form in the unfired structure layer, with the non-solidified regions remaining mechanically sensitive to external influences.

Therefore, in order to form anti-slip structures, the non-solidified material is then preferably removed, particularly blown off. In principle, however, rinsing with water or brushing is possible.

Through the removal of the non-solidified material, the unfired structure layer forms elevations on the cover layer to intentionally disrupt the water film. It will readily be understood that the unfired structure layer is then also disposed only in the regions on the cover layer in which the structure layer was previously also solidified. The cover layer can thus be exposed in regions, so that the coating, less a possible base layer, is embodied in a single layer and in two layers.

In a preferred embodiment of the invention, the unfired structure layer is applied to the cover layer only in certain regions. This approach utilizes the consideration that an unfired structure layer need only be applied where an anti-slip structure is to be subsequently achieved through modification of the unfired structure layer. Special applied masks that allow the application of the structure or frit only where a corresponding opening is provided can also be considered in this regard. The material used can thus be substantially reduced in an especially advantageous manner.

The unfired structure layer is then fired, thus forming a finished sanitary basin. In a preferred development of the invention, the unfired structure layer is first heated to a temperature between the glass transition temperature and the softening point of the enamel prior to fixation with the laser beam. This approach offers the advantage that only a comparatively small amount of energy has to be applied with the laser beam in order to fix the unfired structure layer, since a substantial part of the temperature increase already takes place as a result of the additional heating process. The laser beam is then used only to exceed the threshold for fixation without requiring appreciable energy input for a temperature increase.

After the modification of the unfired structure layer, either in the form of notches or in the form of an area-by-area fixation, the sanitary basin preform then preferably undergoes a final firing, thus forming a finished sanitary basin.

In a preferred development of the invention, the unfired structure layer is modified with the laser beam in such a way that macroscopic structures, particularly interconnected macroscopic structures such as branched or closed grooves, for example, are produced in the structure layer. Such structures can be produced in such a way, for example, that the laser or laser beam is guided along a predetermined direction and macroscopic structures that are created as a result in the form of grooves are formed by notches in the cover layer or two mutually adjacent solidified regions in the structure layer.

However, the formation of interconnected macroscopic structures is not limited to the above-described variants of the method but can also be applied, for example, to a ready-made sanitary basin, particularly a steel enamel basin, in which case the interconnected macroscopic structures are introduced into the fired cover layer by a laser.

### BRIEF DESCRIPTION OF THE DRAWING

The above and other objects, features, and advantages will become more readily apparent from the following description, reference being made to the accompanying drawing in which:

FIG. 1 is a top view of a shower pan with macroscopic structures formed according to the invention;

FIGS. 2A, 2B, and 2C show in section the method steps for forming a grooved structure or frit;

FIG. 3 shows an alternative embodiment of a sanitary basin according to FIGS. 2A, 2B, 2C;

FIGS. 4A, 4B, and 4C show the method steps for forming a structure layer that is fixed in some areas on a cover layer; and

FIG. 5 is a perspective sectional view through an alternative embodiment.

### SPECIFIC DESCRIPTION OF THE INVENTION

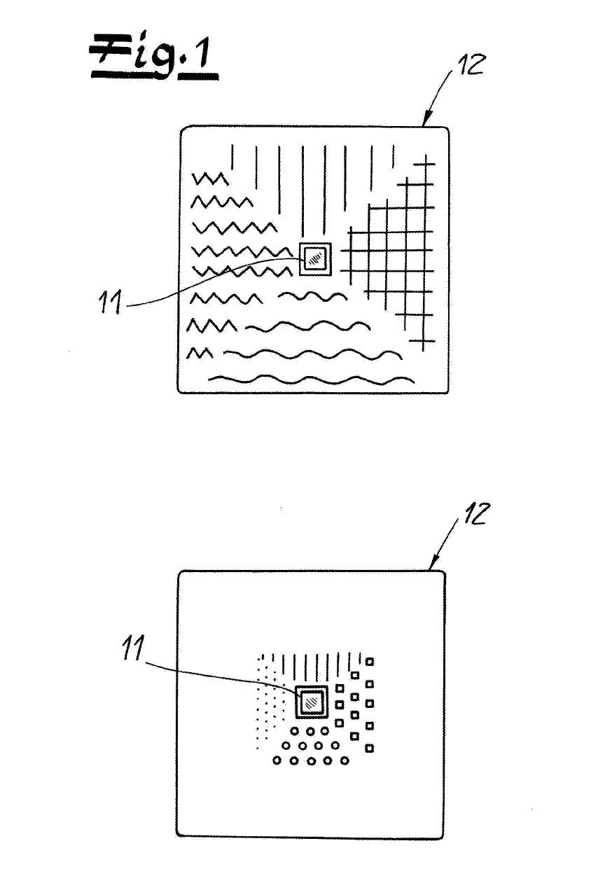

FIG. 1 shows an example of a shower pan with a square base surface and a central drain 11. The shower pan has a slope from a peripheral basin rim 12 to the central drain 11.

This is a shower pan made of steel enamel with an enamel coating on its upper face. Macroscopic structures produced in this enamel coating with a laser beam are also introduced and/or applied, it being possible for these macroscopic structures to have different configurations. Grooves or linear structures are especially preferred. According to the sanitary basin at the top in FIG. 1, this can be realized in the form of linear structures formed for example as channels. If these are aligned with the slope and extend toward the drain opening 11, water can be transported in a targeted manner toward the drain opening 11. Furthermore, wave-shaped channels are also conceivable, or also channels having a zigzag-shape. More important than the orientation on a slope, however, is the formation of an edge that can locally disrupt a film of water. In this context, the effective edge length in particular is decisive, with a not completely straight but a slightly wavy or jagged edge of the macroscopic structures being advantageous.

FIG. 1 also shows interconnected macroscopic structures. According to the upper part of the figure, the sanitary basin has depicted linear macroscopic structures that are formed both toward the drain opening 11 and also parallel thereto, these structures being able to merge into one another or intersect.

The lower part of FIG. 1 shows macroscopic structures that are closed, so that rectangles or circles are created, for example. It is also shown that the macroscopic structures can also be disposed only in some areas on the surface of the sanitary basin.

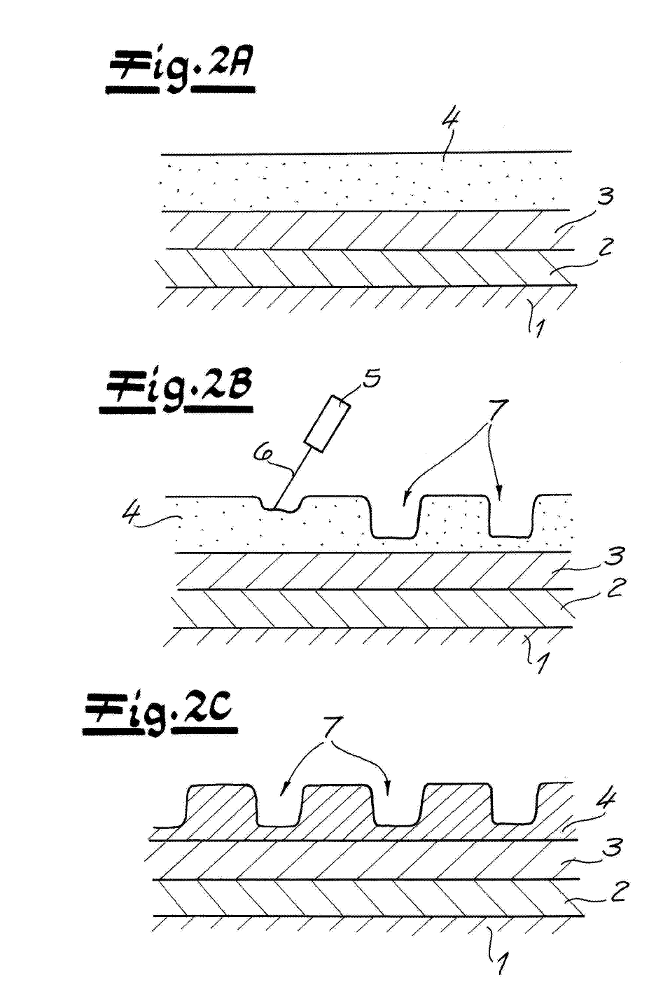

In this context, FIGS. 2A, 2B, 2C show how these macroscopic structures can be formed.

According to FIG. 2A, a base layer 2 is formed on the body 1, with the base layer 2 being applied in a first method step to the body 1 and then fired in a furnace. The base layer 2 solidifies and is fixed to the body 1. In a subsequent step, a cover layer 3 is then applied to the base layer 2 and fired again. Subsequently, a structure or frit 4 of ground enamel frit is applied to the cover layer 3 by spraying onto the cover layer 3.

Then, according to FIG. 2B, the modification of the structure layer 4 is performed by a laser 5 that acts on the structure frit layer 4 with a laser beam 6 such that notches 7 are formed in the frit layer 4. The material of the structure layer 4 is partially removed by the laser beam 6, the laser beam 6 being pulsed in order for high energy density.

Depending on the power of the laser 5 or the strength of the laser beam 6, and depending on the duration of the exposure time of the laser beam 6 in the structure layer 4, notches 7 of different depths can be produced, the depth of the notches 7 being limited by the layer thickness of the structure layer 4. The depth of the notches 7 can only be so large that sufficient residual thickness remains in the region of the notches 7 in the structure layer 4. If the structure layer 4 is intended to cover the underlying layer in terms of color, then a residual thickness of greater than 80 μm is preferably provided. If color coverage is not necessary, the residual thickness can certainly also be smaller.

Once all the notches 7 have been produced with the laser 5 within the frit layer 4, in a next method step according to FIG. 2C, the sanitary basin preform is fired with the body 1, the base layer 2, the cover layer 3, and the frit layer 4 so that the frit layer 4 is solidified with the notches 7 and fixed unitarily to the cover layer 3, which is in turn unitarily fixed to the base layer 2, which is itself fixed to the body 1. As a result, the firing process yields a ready-to-use sanitary basin that, by virtue of the notches 7, has an anti-slip structure on the surface. In order for the anti-slip structure to be as effective as possible, the notches 7 have an average width in the range between 70 μm and 130 μm with a preferably (slightly) wavy edge, the individual notches 7 being arranged with an spacing of 2 mm to 7 mm.

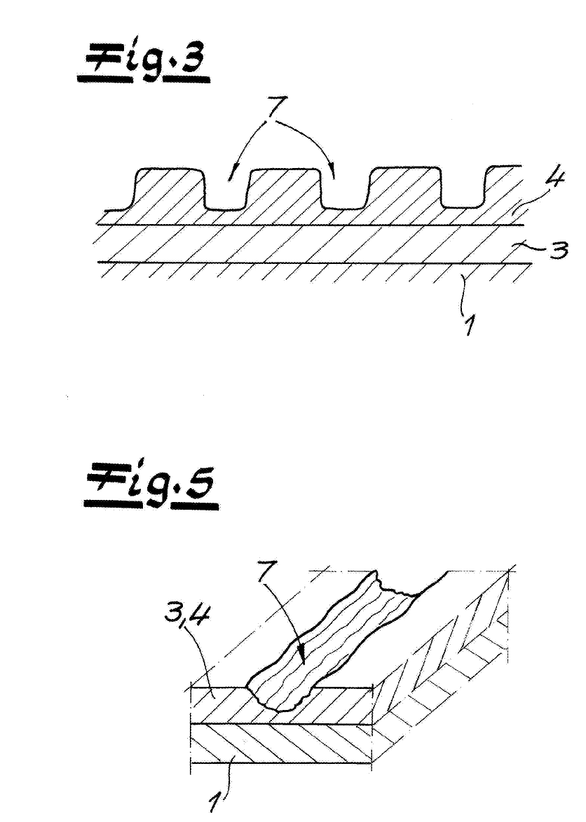

For best visibility, FIGS. 2B to 3 are not to scale.

According to FIG. 3, in such a variant of the method in which the structure layer 4 is modified through the introduction of notches 7, a merely two-layer structure of the coating is sufficient, so that a base layer 2 can be dispensed with in principle. In such a case, the steel body 1 is nickel-plated on the surface, and the material used for the cover layer 3 is so-called direct white enamel.

The method steps for forming such a sanitary basin with an enamel coating without a base layer 2 correspond substantially to the steps already described for a three-layer coating according to FIGS. 2A, 2B, 2C, although the application of a base layer 2 first and the subsequent firing of the base layer 2 are omitted.

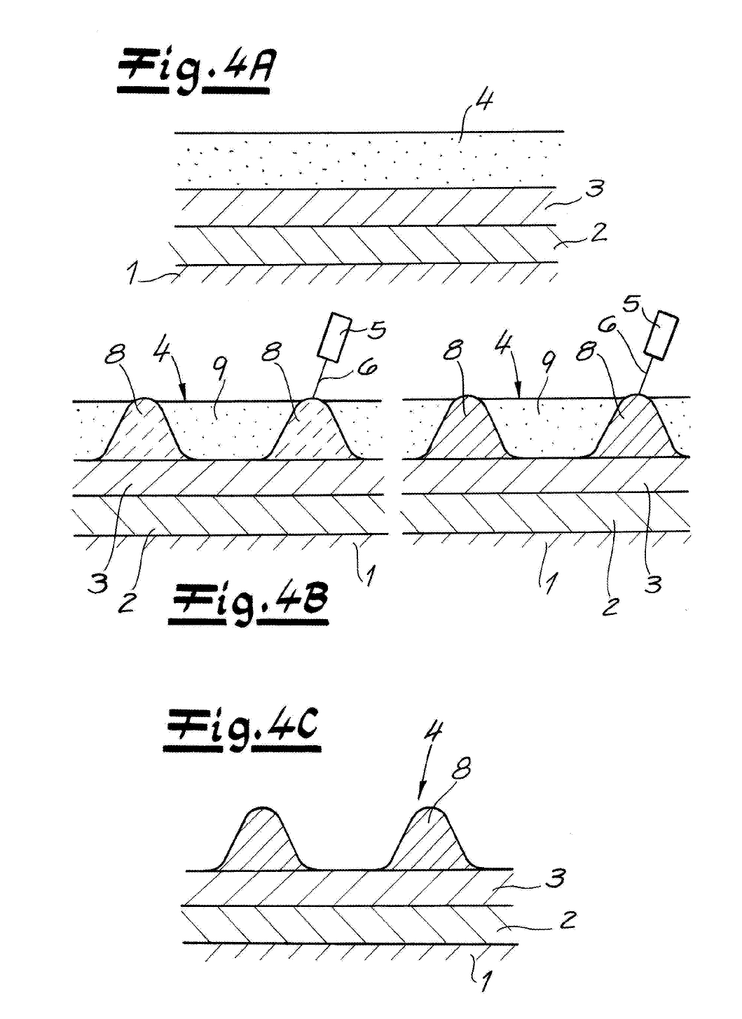

Instead of notches 7, the structure layer 4 can also be modified in another way by a laser beam 6, with anti-slip structures also being formed in the coating in this case. According to FIG. 4A, a base layer 2 is first applied to the body 1 and then fired analogously to FIG. 2A. A cover layer 3 is then applied to the fired base layer 2, fired, and a structure or frit layer 4 is finally applied, with the structure layer 4 being composed of enamel frit here as well. As a result, a three-layer enamel coating of fired base layer 2, a fired cover layer 3, and an unfired frit layer 4 is thus formed.

In a next method step according to FIG. 4B, a laser beam 6 is then generated by the laser 5 and aimed at the surface of the structure layer 4. The type of laser and also the choice of the power of the laser radiation are such that no appreciable removal of material takes place but the frit layer 4 is heated by the action of the laser radiation 6 and thereby hardened. Starting from the point of incidence of the laser beam 6, regions are thus formed in which material 8 solidified by the laser radiation 6 is present and regions that are not subjected to the action of the laser beam 6 and thus have non-solidified frit material 9.

Subsequently, in a method step according to FIG. 4C, the non-solidified material 9 of the structure layer 4 is removed. The removal is performed by blowing with air or another gaseous medium, by rinsing with water, or by brushing, for example. The structure layer 4 is then present only in the form of the material 8 that has been solidified by the laser 5 or laser beam 6, with complete removal of the non-solidified material 9 not being absolutely necessary. In principle, it is also possible for the structure layer 4 to be freed only partially from the non-solidified material 9, so that the non-solidified material 9 is then fixed in a final firing process. In the present case, however, the non-solidified material 9 has been completely removed and the structure layer 4 forms a structure that is present in some areas on the cover layer 3.

Finally, FIG. 5 shows an embodiment of the sanitary basin in which the coating is formed by only one layer. For this purpose, the enamel referred to as direct white is applied as a slip in sufficient thickness and dried, with the structuring being performed directly in the biscuit layer that is formed in this way. The cover layer 3 thus simultaneously forms the structure layer 4 with the notch 7.

We claim:

1. A method of making a sanitary basin, the method comprising the steps of:
providing a steel basin body;
coating a face of the body with a layer of enamel; and
forming macroscopic structures in the enamel coating with a laser beam.

2. The method defined in claim 1, wherein the structures are interconnected.

3. The method defined in claim 1, wherein the macroscopic structures have a depth of from 10 μm to 150 μm.

4. A preform for a sanitary basin made according to claim 1, the preform comprising:
the body;
an enamel coating on the body; and
an unfired frit layer modifiable by a laser beam on the enamel coating.

5. The preform defined in claim 4, wherein the enamel coating includes:
a base layer;
a cover layer between the base layer and the frit layer.

6. The preform defined in claim 4, wherein the laser beam forms notches in the unfired frit layer.

7. The preform defined in claim 5, wherein the laser beam fuses and fixed the unfired frit layer to the cover layer only in some areas, the method further comprising the steps of:
hardening the fused areas to bond them integrally to the cover layer and form the macroscopic structures; and
removing the unfired frit layer between the areas.

8. The preform defined in claim 4 wherein the macroscopic structures have a thickness in the range from 100 μm to 200 μm.

9. The sanitary basin formed according to the method of claim 1.

10. The method defined in claim 1, the enamel coating comprises a cover layer either on a base layer or on the body, with the cover layer first being applied and then the unfired frit layer being applied to the cover layer.

11. The method defined in claim 1, wherein the macroscopic structures are burned into the frit layer by the steps of:
burning off a part of the frit layer with the laser beam; and
thereafter firing the body with the layers to solidify the portion of the frit layer that was not burnt off.

12. The method defined in claim 1, wherein the macroscopic structures are burnt into the frit layer.

13. The method defined in claim 12, the steps of:
fusing areas of the frit layer with the laser beam.

13. The method defined in claim 12, further comprising the step of;
removing the unfused portions of the frit layer.

14. The method defined in claim 12, wherein the unfused portions of the frit layer are removed by being blown off.

15. The method defined in claim 1, wherein the frit layer is applied to the cover layer only in some areas.

16. The method defined in claim 1, further comprising, prior to burning with the laser beam, the step of:
heating the frit layer to a temperature between a glass transition temperature and a softening point of the enamel.

17. The method defined in claim 1, further comprising, after burning with the laser beam, the step of:
final firing of the body, cover, and structured frit layer.

18. The method defined in claim 1, wherein the unfired frit layer is modified with the laser beam such that macroscopic structures are produced in the unfired frit layer.

19. The method defined in claim 1, wherein the frit layer also forms the cover layer in a single firing process.
